(19) United States
(12) Patent Application Publication
(10) Pub. No.: US 2002/0049692 A1
(43) Pub. Date: Apr. 25, 2002

(54) Systems and methods for development of an interactive document cluster network for knowledge

(76) Inventor: Srinivas Venkatram, Mumbai (IN)

Correspondence Address: Rashida A. Karmali, Suite 2525, 230 Park Avenue, New York, NY, 10169, US

(21) Appl. No.: 09/902,284

(22) Filed: Jul. 10, 2001

Related U.S. Application Data
(60) Provisional application No. 60/242,390, filed on Oct. 20, 2000.

(51) Int. Cl. G06F 17/00

(52) U.S. Cl. 706/59; 706/45

(57) ABSTRACT

The present invention relates to knowledge management systems and methods and more particularly to an Interactive Document Cluster Network (InDoCNet) and methods of capture, storage and retrieval of knowledge wherein the unit of interaction with knowledge is a “cluster of knowledge”. This “cluster of knowledge” includes, not only the document, but also all the associated ides, responses, evaluations, or inter-relationships which have been generated”.

The system comprises of an interactive document cluster, a communication and sharing protocol, a plurality of content hubs and a set of user interfaces called knowledge encounter maps.

### CROSS-REFERENCE TO RELATED APPLICATIONS

This Application is a Continuation-In-Part of co-pending U.S. patent application Ser. No. 60/242,390, the entire disclosure of which is incorporated herein by reference.

### 1. FIELD OF THE INVENTION

The present invention relates to knowledge management systems and methods and more particularly to an Interactive Document Cluster Network (InDoCNet) and methods of capture, storage and retrieval of knowledge wherein the unit of interaction with knowledge is a “cluster of knowledge”. This “cluster of knowledge” includes, not only the document, but also all the associated ideas, responses, evaluations, or inter-relationships which have been generated, discovered or created as a result of one or more interactions between a group of users or knowledge seekers and that document or piece of knowledge. Thus, the core document provides access to the core document plus the fragments of knowledge or to core document plus fuzzy knowledge. The invention also relates to the sharing of such fragments or fuzzy knowledge across a network of users such that the same fragment is multiply used in multiple document cluster contexts.

### 2. BACKGROUND OF THE INVENTION

The Internet has opened up the opportunity for on-line and low cost worldwide distribution of knowledge and learning materials to users. Almost every single knowledge management initiative, whether in corporate, commercial, educational or personal context attempts at least in part to bring the knowledge base close to the actual tasks being carried out by the user. In other words, the goal is to seek “just-in-time knowledge”. A major challenge lies in making use of Internet technology to deliver highly customized knowledge to each individual user. For example, in the case of customized training, each user should be able to read, interact with and/or download materials, which address the user's needs as a function of the user's current level of learning. Existing systems for collecting and managing information have been inadequate to meet such needs because they do not provide for effective assessing, evaluating and updating of information or knowledge within an organization or system. In other words, existing systems do not adequately address the accrual of knowledge resulting from activity concerning the user's needs as determined from a variety of perspectives, which is an important aspect of succeeding in the electronic global environment. As current information sources become larger and more complex to serve a variety of knowledge workers with particular information needs, providing knowledge workers within an organization with customized packaged knowledge becomes increasingly important to the success of any organization.

One of the critical issues being addressed by managers in large corporations and elsewhere is the issue of capturing, storing and retrieving tacit knowledge. Tacit knowledge includes the experiences, ideas, reactions and suggestions that people have assimilated in their minds or heads and which could be transferred or made available to others in their group, their peers and subordinates within the organization.

According to the present invention, the problems and disadvantages with existing knowledge management systems and methods have been substantially eliminated.

### 3. SUMMARY OF THE INVENTION

According to a broad aspect of the present invention systems and methods are provided whereby knowledge is captured, stored and retrieved on another dimension or set of knowledge paths defined herein as dimensions of concern. It is empirically found that tacit knowledge is built around specific themes which are perceived by knowledge creators or seekers as of direct value to them.

The present invention provides a classification architecture which is able to allow the creators of knowledge to add to the data on dimensions relevant to them and the users of knowledge to retrieve the data on other dimensions more relevant to them. This classification is built on identifying the critical or universal axes of concern which drive the creation and storage of data related to an organization.

The present invention relates to knowledge management systems and methods and more particularly to an Interactive Document Cluster Network (InDoCNet) and methods of capture, storage and retrieval of knowledge wherein the unit of interaction with knowledge is a “cluster of knowledge”. This “cluster of knowledge” includes, not only the document, but also all the associated ideas, responses, evaluations, or inter-relationships which have been generated, discovered or created as a result of one or more interactions between a group of users or knowledge seekers and that document or piece of knowledge.

The InDoCNet technology of the present invention is built on four novel concepts:

(a) An interactive document cluster which is a document display software which contains access to and can display a number of documents and also display a number of knowledge or document fragments which are “attached to it” through various formats. This device called an InDoC Tool (Interactive Document Software Tool) allows users to (i) navigate and choose among documents on the basis of an explicit logic or structure; (ii) add, annotate, or edit documents through the addition subtraction or modification of various “knowledge fragments” (which are new documents ‘added on’ to the existing documents.); (iii) store, display, retrieve, or address these knowledge fragments for the purpose of usage by subsequent users of the same tool, or for the purpose of sharing and distributing this knowledge fragment through the connected InDoC Communication System.

Each InDoC Tool could carry (i) one or more highly purposive visual metaphors and/or learning structures for the purpose of navigation; (ii) document display and delivery tools; (iii) experience sharing interfaces, which are specially designed for the purpose of provoking tacit knowledge creation and sharing and (iv) an implicit document storage and distribution system that allows fragments to be added and automatically tagged for distribution or local storage.

Knowledge fragments are captured and delivered through the experience of sharing interfaces at the structural level. At this level they are stored on the basis of dimensions of concerns.

Knowledge fragments are captured, stored and delivered around the interactive document clusters at the level of the individual document or content within the structure.

(b) A new communication and sharing protocol that allows (i) each knowledge fragment to be appropriately addressed and tagged automatically on the basis of the “point of origin” within the network; (ii) the knowledge fragments to be “dimensionalized” on the basis of knowledge needs or ‘dimensions of concern’; and (iii) shared and distributed among all users of a certain class on the basis of these dimensions.

(c) An InDoC Communication System, which comprises of a number of Content Hubs. Each hub has a number of InDoC tools connected to it and is responsible for organizing and storing the sharable and other fragments created in these tools. Each hub allows for the knowledge fragments created to be distributed to all other hubs and conversely receives and stores relevant fragments from any other hub in the system on the basis of the communication protocol, (much like the Internet which has numerous servers which talk to each other on the basis of an Internet Protocol). Thus, any number of hubs may be added or subtracted to the system. As long as the protocol is maintained, each hub will pass on and receive fragments from the next hub, and make selections on the basis of relevance defined by the communication protocol. As this goes on, from each hub to related hubs, every knowledge fragment gets distributed and selected by all relevant hubs and made available to the associated “spoke InDoC Tools”.

(d) A set of user interfaces called Knowledge Encounter Maps. Each knowledge encounter map is usually built around a specific action situation such as writing a report, or performing an appraisal, etc. The map represents an “outcome space” which is a set of inter-related intermediate outcomes, which may or may not flow logically from each other, but could flow out of the variations in real-life situations, which a user may face. (For example, a series of what ifs describe multiple scenarios of events; in practice however, each time the user is completing the task, he will encounter only a fraction of the total universe of what ifs in that instance.) Thus each event, when encountered (and only when encountered), triggers off a knowledge need or a knowledge-sharing situation.

This will result in the user selecting an appropriate InDoC Tool corresponding to the situation picked. The InDoC Tools could be connected to different content hubs and can contain different dimensions of concern.

The InDoC system of the present invention describes the model for the capture, storage and retrieval of tacit knowledge. The system comprises knowledge fragments which are linked to structure and knowledge fragments which are linked to the content with the structure.

### 4. BRIEF DESCRIPTION OF THE FIGURES

For a complete understanding of the present invention and for further features and advantages thereof, reference is now made to the following description taken in conjunction with the accompanying drawings in which:

FIG. 1a illustrates structure of an InDoC Tool and FIG. 1b illustrates a display interface of the InDoC Tool.

FIG. 2 represents the components of the InDoCNet, which is a layered knowledge-sharing network. The InDoCNet comprises of numerous InDoC Tools, which are interactive document clusters connected through a software program that organizes them; each of these InDoC Tools is connected to a Content Hub, such that any content hub can have multiple InDoC Tools; and the content hubs themselves are connected to each other in a communication system that uses a specific choice and relevance protocol, based on dimensions of concern; the tools are accessible to users via a Knowledge Encounter Map, or through any other kind of user interface.

FIG. 3 represents the flow of operations in the InDoCNet. Wherein the figure describes how a tacit knowledge fragment, which is entered by a user is tagged according the relevant dimensions of concern, and shared via the content hubs across the network, such that the same fragment is displayed on other InDoC Tools as per the sharing protocol. Hence the content hubs enable the meaningful recontextualization of tacit knowledge fragments from one point of use to another.

FIG. 4 illustrates the display interfaces for experience sharing.

FIG. 5 illustrates the operations of the InDoCNet and sharing taking place on the “dimensions of concern”.

FIG. 6 illustrates the two basic types of knowledge fragment sharing;

FIG. 6a describes knowledge sharing at the structure level and FIG. 6b at the content level.

FIG. 7 illustrates the multiple layers of knowledge sharing, which is based on the outcome levels or perspectives, within which sharing takes place. This represents the typical sharing mechanism for large organizations, which is architected on the basis of the knowledge organization, described in DISHA, in a co-pending application entitled “Systems and Methods for Directed Knowledge Management Using the DISHA Platform”, submitted concurrently by the applicant. This represents the communication protocol.

FIG. 8 represents the basis for the knowledge sharing protocol and illustrates the same. The “Dimensions of concern” are derived from a role and are defined for an Outcome Level. These dimensions of concern, are organized into orthogonal “idea sets”. In this case, the orthogonal dimensions for the role “sales” are configuration, competitor and client concern. Each dimension forming an idea set comprising of variable “points of concern”, example—client concern, may have reliability, maintenance costs etc. as points of concern.

FIG. 9 represents the methodology involved in developing the appropriate knowledge sharing and communication protocol for InDoCNet

FIG. 10 represents some of the possible functions of a Content Hub, within the InDoCNet.

FIG. 11 illustrates specialized embodiments of the InDoCNet; 11a illustrates a “Case Cluster Network”, 11b illustrates a “Learning History Cluster Network”, 11c, illustrates an “Insight Question Cluster Network”, 11d, illustrates a “Thought Strings Cluster Network” and 11e, a “Troubleshooting Cluster Network”.

FIG. 12 illustrates an intelligent content agent with a tool description “what if”

FIG. 13 illustrates an example of a software metaphor tool—a radar metaphor tool in the case of a “competitor radar tool” to benchmark against competition

FIG. 14a represents the knowhow distribution in a community of practice. Each structure set representing a knowledge transfer protocol.

FIG. 14b represents the intelligent content hubs based on the layered knowledge sharing protocol.

### 5. DESCRIPTION OF THE PREFERRED EMBODIMENT

Organizations have found the task of capturing, storing and retrieving such knowledge difficult to implement in practice. The primary factor has been the reluctance of the individuals involved to contribute to the system. It is found that even sophisticated knowledge management systems which have complex methods of analysis and retrieval are unable to incentives or encourage people to add to the system.

A further, equally important problem is the issue of structuring and retrieving such data, which in the final analysis may appear in numerous forms ranging from a single line to a full blown report describing an event or some learnings associated with a project, or an event.

The problems above have become particularly acute in recent years wherein organizations are being forced to continuously track and respond meaningfully to the ‘soft inputs’ that come in from the environment and from people within the organization. Soft inputs could include a customer reaction about the company's product or even a comment about a competitor's product made in the course of sales conversation.

Another manifestation of the problem lies in enabling managers to get a more multi-dimensional view of a problem by way of differing perspectives; without having to resort to time consuming and difficult to set up brainstorming sessions.

Another manifestation from an information delivery point of view is the problem of ‘issue centricity’. To elaborate, one may often have a particular perspective or issue to be dealt with in one's mind while going through a set of documents. On another occasion, one may rerun through the whole document set, this time from a different perspective altogether. These differences in perspective will not only influence the emphasis paid to various issues, but will also modify to a great extent the choice of support and additional documentation around the ‘core document set’.

Each of the examples above reflect a different manifestation of the tacit knowledge problem—capturing a reaction, incorporating unplanned for experiences and environmental inputs into the organizational memory and creating alternative structures of access to a document set based on the perspective or central issue defining the knowledge access situation. The present invention provides systems and methods which achieve each of the objectives.

The problem, defined in context of the capture, storage and retrieval of tacit knowledge, can be extended to include almost any knowledge interaction situation wherein the unit of interaction with knowledge is no longer an individual document or report, but instead is a ‘cluster of knowledge’ which includes not only the document, but also all the associated ideas, responses, evaluations, inter-relationships, which have been created or discovered as a result of the interaction between a group of human beings and that piece of knowledge.

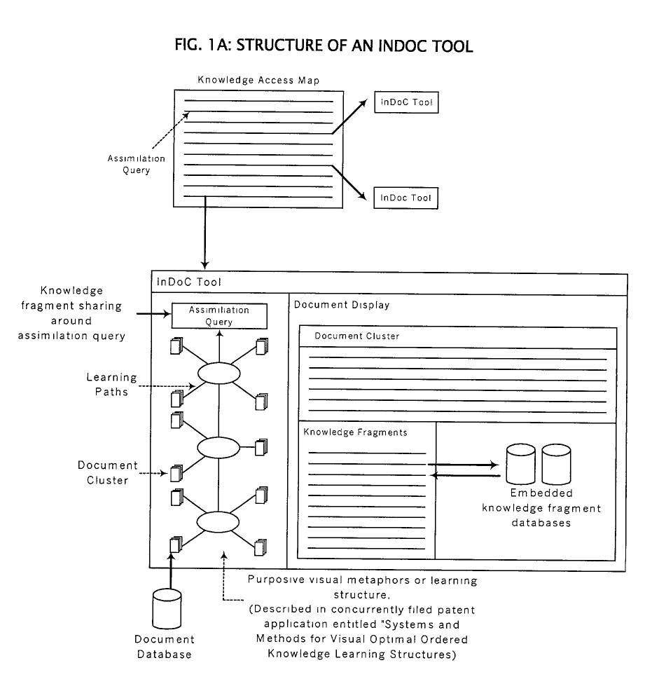

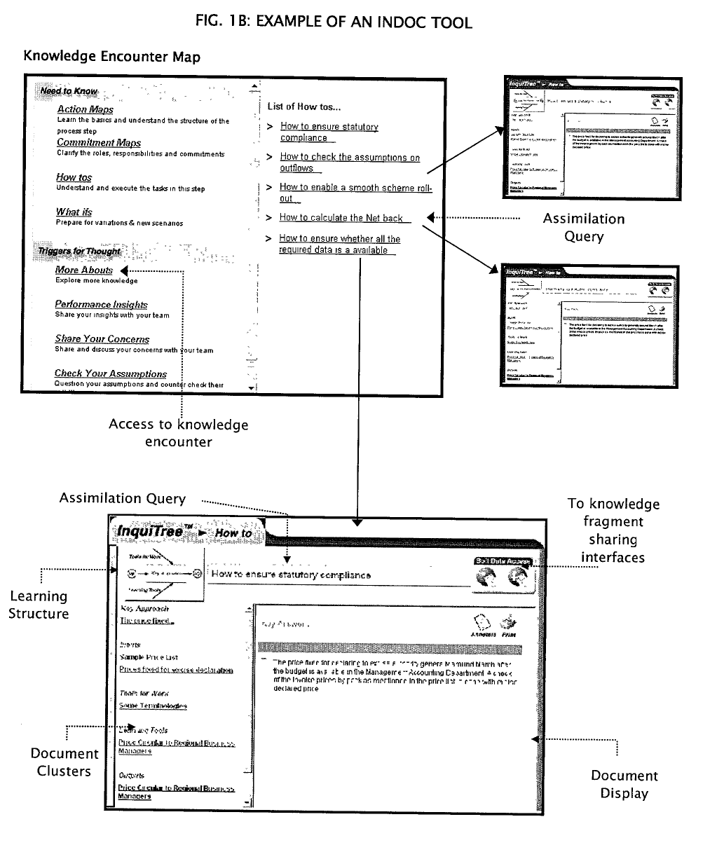

The Structure of InDoC Tools (See FIG. 1)

The central paradigm used in the structure of an InDoC Tool is the notion of knowledge pathway. A knowledge pathway represents a mode of access to a cluster or set of knowledge documents. The mode of access is defined on three fundamental dimensions: (a) the assimilation query (b) the choice of learning path (c) the type of document. To elaborate the present invention more specifically and particularly:

1. Any access to knowledge in a work situation is usually defined by the seeker in terms of a question or query which may be formulated either in explicit terms or intuitively by the seeker. The query can include questions such as ‘what if’, ‘how to’, ‘if . . . then’, etc. (These types of queries are commonly dealt with in a popular type of information presentation called ‘faqs’-frequently asked questions). The appropriate formulation of such a query is intended by the seeker of knowledge to adjust or fine tune his or her approach to the knowledge base and is defined here as the ‘assimilation query’.

2. The choice of learning path represents the type of learning or assimilation style in which the seeker of knowledge chooses or prefers in that specific situation. For example, one user may prefer to build a theoritical base in order to deal with a situation, while another may prefer to carry out a specific task and generate a set of learnings out of that process, while yet another may prefer to understand how the particular piece of knowledge has been used in different situations and thereby draw a comparision to his own situation. Seekers of knowledge usually make these choices intuitively, but are usually fairly clear about their preferences even if unarticulated. Further, the same seeker may select or use a multiplicity of such assimilation styles in order to gain command over a subject or ‘get’ an idea. These assimilation styles are defined here as ‘learning paths’.

3. The third dimension is the choice of document type which is the ‘fuzziest’ set of choices in that users are quite willing to move from one document type (say formal report) to another (say comment made on the subject) to another (say audio clip) or yet another (say video clip).

The central problem here is the structuring and inter-relationship between these individual documents so that the user is able to seamlessly move from one document type to another, within the context of his/her assimilation query and the choice of learning path.

This is achieved in the following manner: One, the assimilation query which is the first stage of the knowledge seeking process and which is triggered off by context, is presented to the user along with other assimilation queries in the knowledge encounter map.

Each knowledge encounter map is usually built around a specific action situation such as writing a report, or performing an appraisal, etc. The map represents an “outcome space” which is a set of inter-related intermediate outcomes, which may or may not flow logically from each other, but could flow out of the variations in real-life situations, which a user may face. (For example, a series of what ifs describe multiple scenarios of events; in practice however, each time the user is completing the task, he will encounter only a fraction of the total universe of what ifs in that instance.) Thus each event, when encountered (and only when encountered), triggers off a knowledge need or a knowledge-sharing situation. Thus, the assimilation queries are displayed in the knowledge encounter maps.

Selecting the appropriate assimilation query will result in the selection and display of the appropriate InDoC Tool.

The InDoC Tool contains (i) one or more highly purposive visual metaphors and/or learning structures for the purpose of navigation of knowledge. For example, a commitment map, which describes the commitments and input-output relationships between members of a team, enables a user to make a visually aided selection of appropriate document. (To be more precise, the structure and organization of the documents are embedded and displayed by the visual structure). Another example could be the use of a learning structure (described in Visual OOKS patent 117.009). (ii) To further select the appropriate document, the user is provided with choices of learning paths at each level or node within the visual or learning structure. (iii) On selection of the learning path, the user is given the option to either select from a listing of documents (document path). The tool may contain hyperlinks or copies of documents, or a retrieval mechanism to call document options and display them to the user.

The key feature of the InDoC Tool is that it provides a highly localized task or situation level context for knowledge sharing and capture of tacit knowledge. Further, it provides the delivery framework for displaying explicit documents and the tacit knowledge generated around these documents. By providing a structure for navigation and selection of documents, the InDoC Tool allows the directed use of specific documents and presents clearly defined opportunities for knowledge to be captured and stored within the system.

The Notion of ‘Interactive Document Cluster’ Networks

The present invention provides a method whereby tacit knowledge is captured, stored and retrieved on another dimension or set of knowledge paths defined by us as dimensions of concern. It is empirically found that tacit knowledge is best extracted and best used when the knowledge is built around specific themes which are perceived by knowledge creators or seekers as of direct value to them.

The creators of tacit knowledge often do so because they are motivated by concerns most relevant to there own lives or activities. Users of the data generated by these creators often retrieve and utilize the knowledge in terms of issues or concerns close to them which may often be radically different in apparent form then those related to the creators of the knowledge. Therefore the central challenge facing any knowledge management effort which aims at collecting, storing and retrieving tacit knowledge lies in creating a simple but powerful mechanism that allows users and creators of knowledge to interact with knowledge on the themes or knowledge pathways that are most relevant to them while ensuring that no knowledge or valuable insight is lost in such a process.

What is proposed is a classification architecture which is able to allow the creators of knowledge to add to the data any dimensions relevant to them and the users of knowledge to retrieve the data on other dimensions more relevant to them. This classification architecture is built on identifying the critical/universal axes of concern which drive the creation and storage of data related to an organization.

This classification architecture of the present invention allows numerous fragments of knowledge collected almost as ‘asides’ within a particular work process, for example, a sales process, to be quickly and meaningfully classified in a manner that allows retrieval of the same fragment by numerous other users of that knowledge within that organization, each on a different dimension.

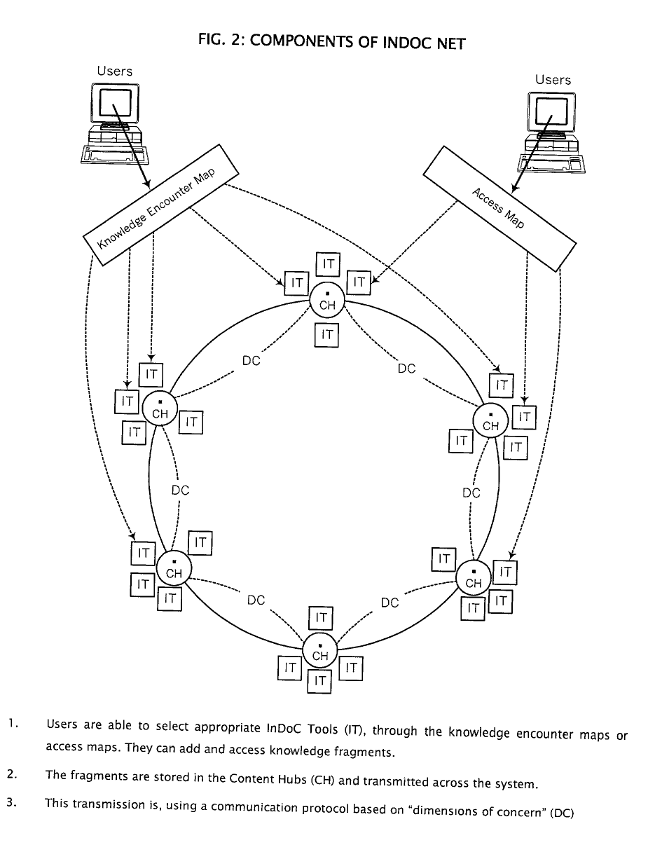

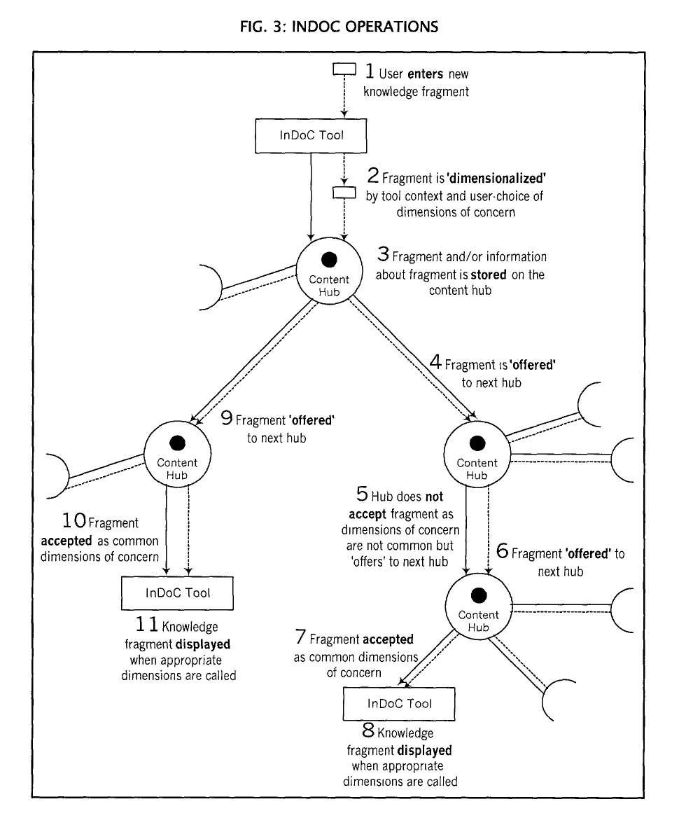

This classification architecture of the present invention underlies a set of entry interfaces and display interfaces which together enables an organization to collect store and retrieve tacit knowledge more efficiently and effectively through the organization. This set is called an interactive document cluster network (InDoCNet) with any single document display (comprising of one set of documents selected on any one axis of concern) being called an interactive document cluster (InDoC), which may be displayed to the user in the form of an InDoC Tool or as an independent document cluster in the case of any other knowledge presentation system. (See FIGS. 2 and 3)

Description of Various Embodiments of InDoCNetworks (InDoCNet)

The invention relates to numerous different interactive document cluster networks. Each network will have four components—with varying degree of emphasis across networks on each component. The components are (a) the dimension or axes of concern (b) the locus of concern (c) the knowledge fragment and (d) knowledge strings and string elements.

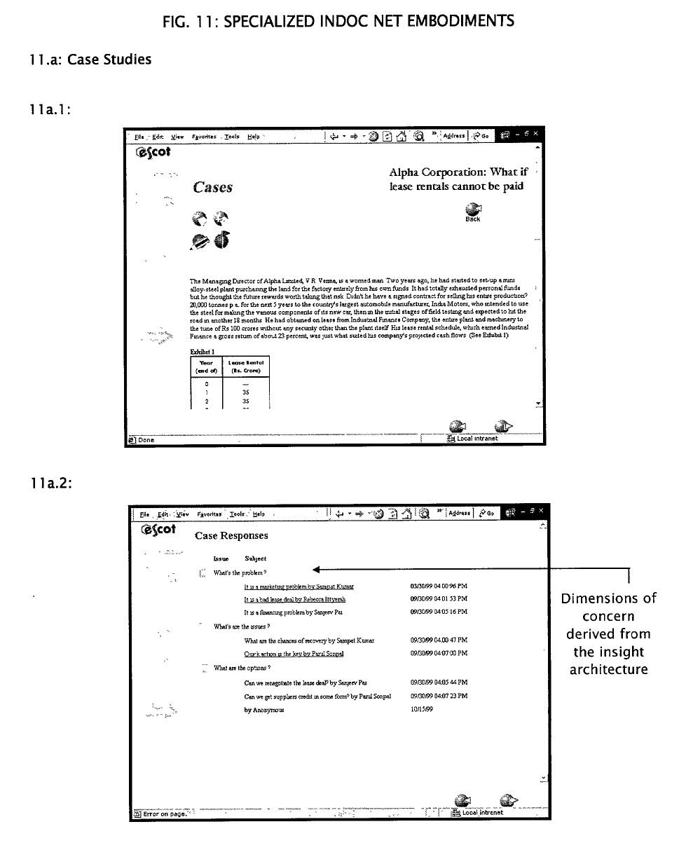

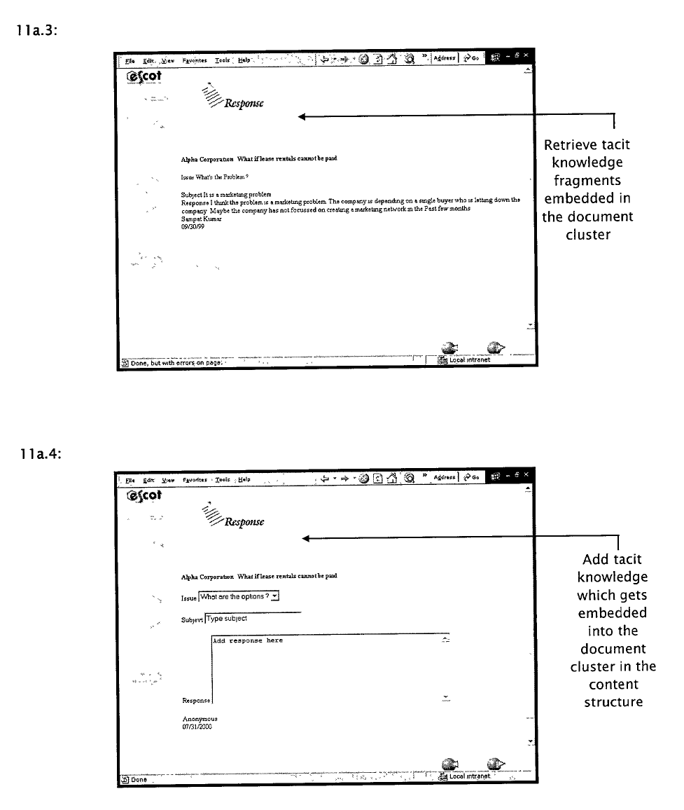

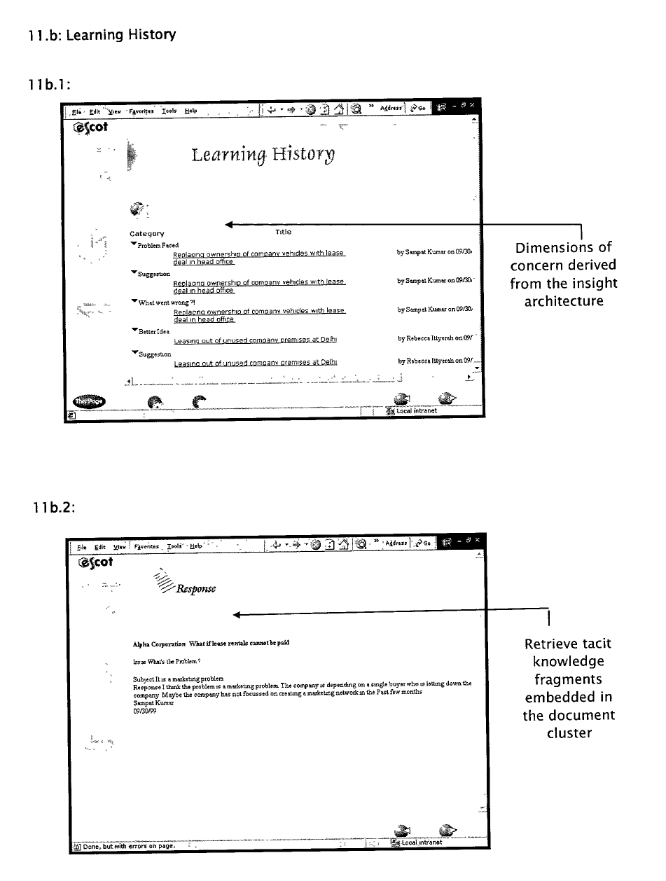

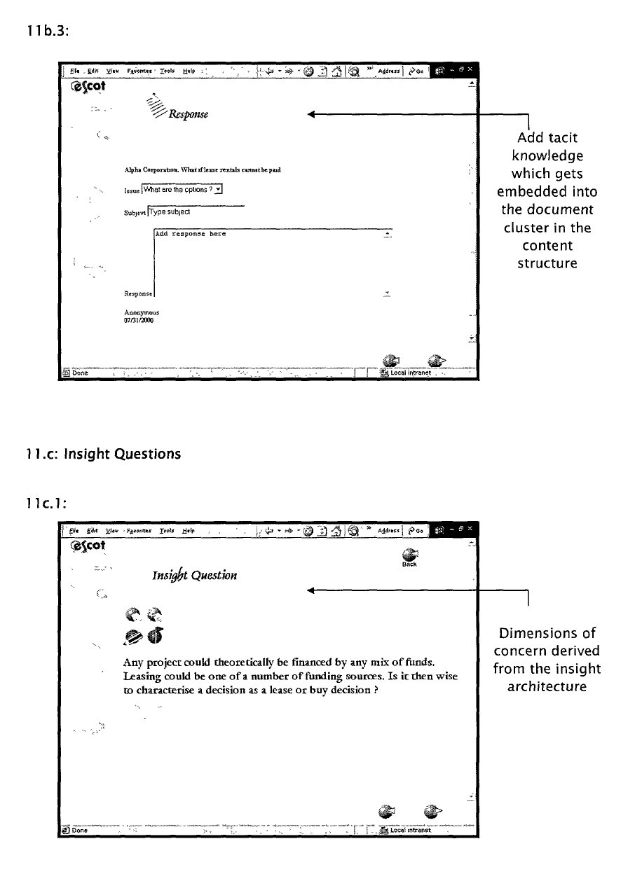

Each cluster network will relate to a specific area of organization or community activity. Some of cluster networks referred to in this document include Sales InDoCNet, Learning History Cluster Networks, Case Cluster Networks, Insight Cluster Networks and Activity Network Clusters (See FIGS. 11a to 11e).

The dimensions or axes of concern will vary across networks. The InDoCNet related to the sales process, for example, is built on the dimensions of customer configuration and competition. The Learning History Cluster Network is built on the dimension of organizational activity. The Insight Cluster Networks is built on the dimension of organizational assumptions. The Case Cluster Networks is built on the dimension of issues of critical concern to the organization.

The locus of concern is a mechanism which is used to provoke structures or enable users to respond and use the network more meaningfully and effectively. For example, the Case Cluster Network uses a set of pre-defined case study as the locus of collecting tacit knowledge. The insight cluster network uses an ‘insight question’—a specially designed type of question meant to unearth and re-assess assumptions underlying people's work or the activities and goals of the communities.

The unit of knowledge, which is captured, stored and retrieved from the system is called the knowledge fragment. A knowledge fragment may or may not have any pre-defined structure and may be in any form amenable to storage and retrieval in a system.

The knowledge string and string elements refer to responses and reactions to the knowledge fragments. The strings may comprise of any number of string elements, all of which must be linked to the knowledge fragment and addressed only in relation to the knowledge fragment. Every time a knowledge fragment is called for, the associated string will also be available to users for review, with if necessary appropriate filters.

The Structure of an InDoCNet

InDoCNet is the framework for the physical distribution and reframing of context for knowledge fragments. The InDoCNet connects to the user via InDoC Tools but is not limited by the InDoC Tools and can be accessed by users at a variety of levels through a variety of navigational or knowledge access interfaces depending upon the design of the knowledge delivery system. (See FIG. 2 and 3)

The starting point for the InDoCNet may be seen as the experiencing sharing interface. The experience sharing interface performs the function of facilitating or triggering the creation and storage of tacit knowledge. It is found in practice, that although excellent mechanisms may exist for the capture or storage of tacit knowledge, users do not usually take the trouble of formulating their tacit knowledge into a clearly articulated knowledge fragment. It is found in practice, that users do formulate knowledge fragments when they are sufficiently motivated by a context or situation to present their viewpoint or “hidden knowledge” of the situation. For example, the presence of a well-defined question along with alternative viewpoints from various users of the system, can often encourage users to add their own perspective to the same question, in agreement or contrast to others viewpoints. Similarly, it is found that the use of specific phrases such as “reality check” or “what's your concern?” again results in higher incidence of tacit knowledge formulation and retrieval.

Thus, experience sharing interfaces are specially designed for the purpose of provoking tacit knowledge creation and sharing and may be of different types.

These interfaces may be located at various points of the knowledge delivery system. Equally important, the choice of interface results in the appropriate protocol level being invoked and the sharing paradigm being defined for that document.

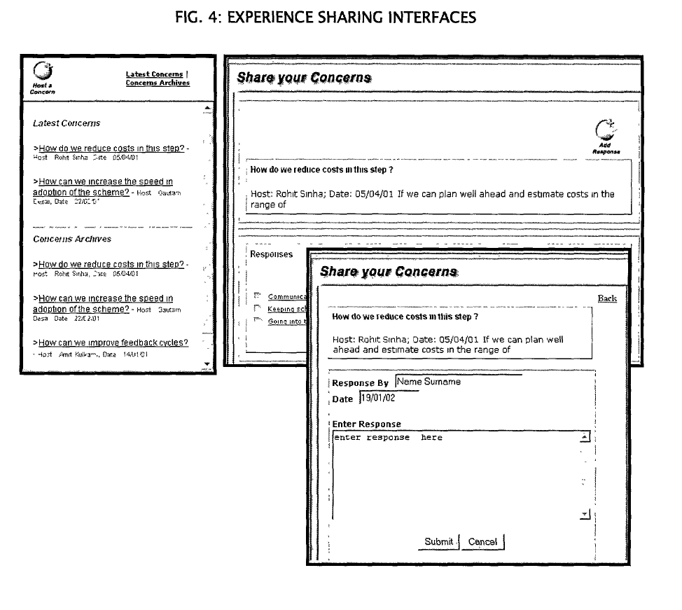

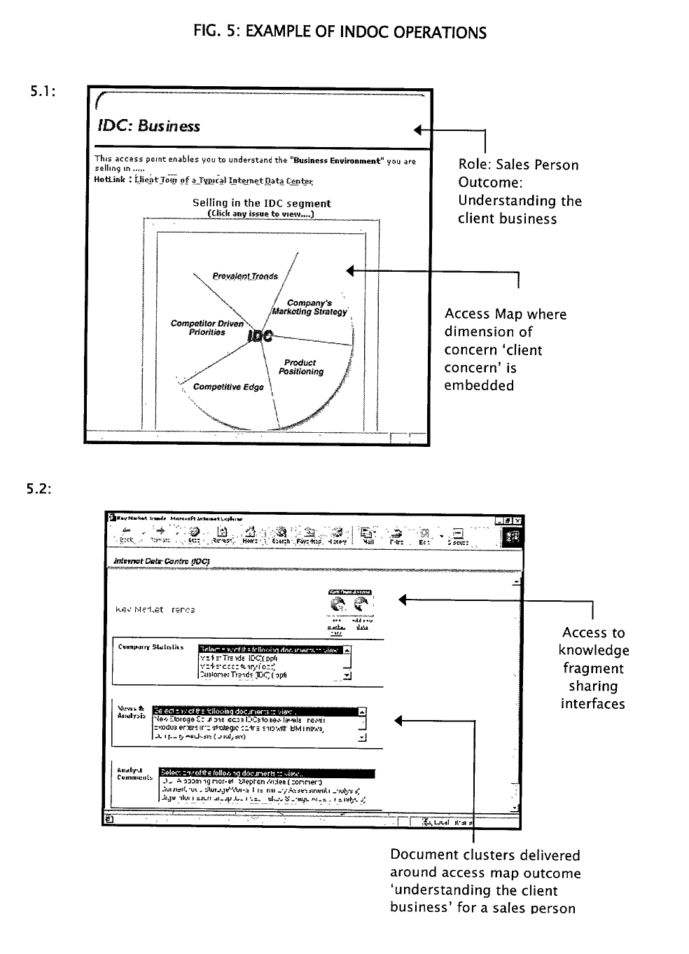

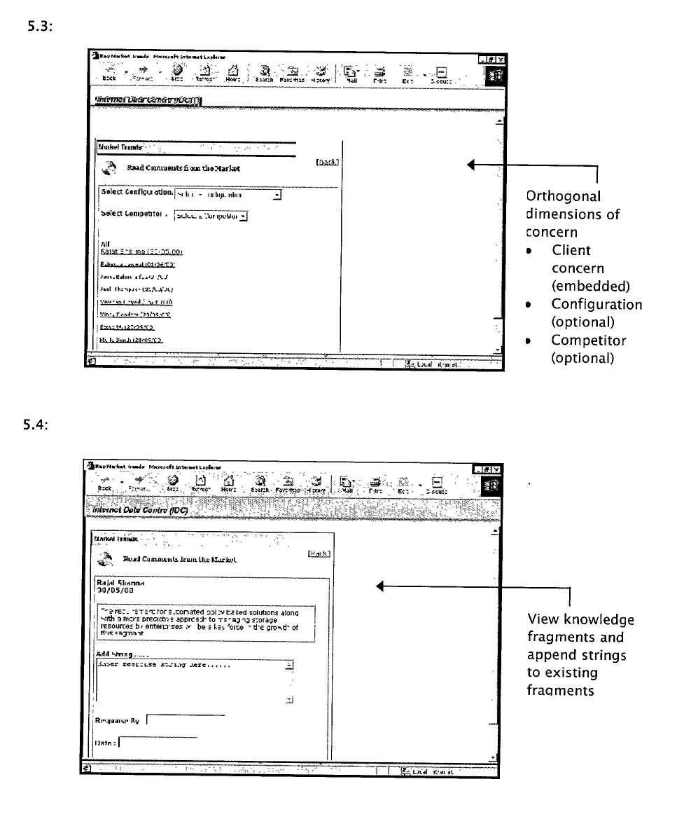

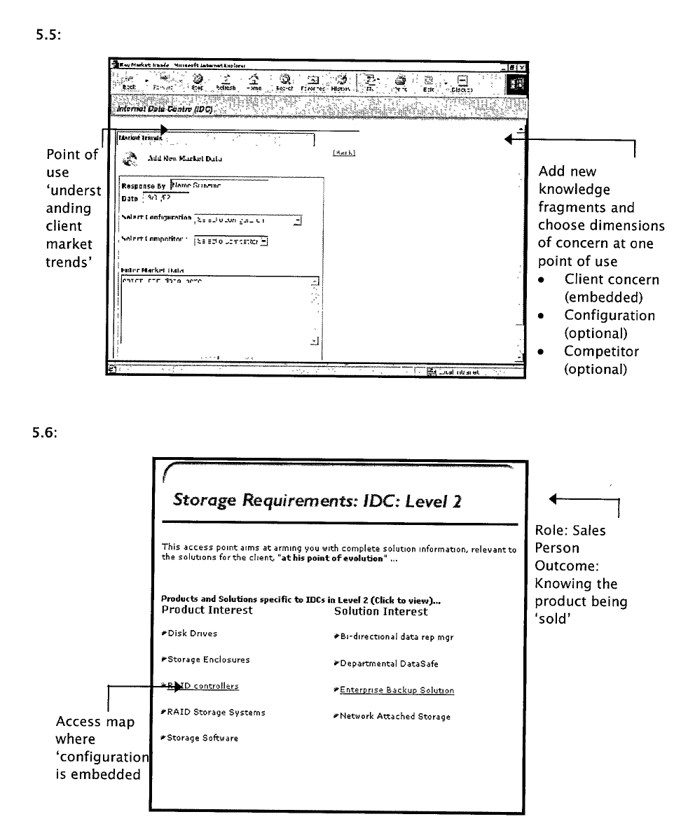

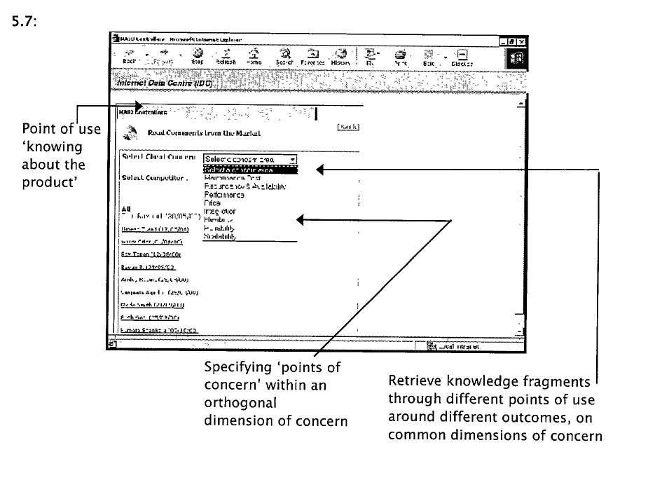

In all these cases, the interface opens up into a knowledge entry, storage and editing interface, and an implicit or explicit mechanism for defining the dimension of concern on which the knowledge is to be shared. For example, if the sharing is highly local, as in the case of a commitment map, the dimension of concern is not articulated, but is implicitly defined as “better communication and adherence of the commitment protocol among group members.” On the other hand, if the ESI is at the level of a process, (for example sales process), then a clearly defined set of dimensions are articulated to the user for selection (in case of sales process, the dimensions may be configuration, customer, and competition). (See FIGS. 4 and 5)

It is found that there are multiple layers and levels on which knowledge is shared among different groups. The basic approach to selection of the appropriate layer and the dimensions of sharing, can be defined at two levels—one, at the structural level, and two, at the content level.

When documents are captured at the content level, it means that those fragments are called upon as and when that specific document or families of that document are called upon by the user. Content level knowledge sharing is usually context and user-need independent. An example would be a case study, were the capture and storage of documents are organized around the specific dimensions on which the case is to be evaluated such as problems, alternatives, etc.

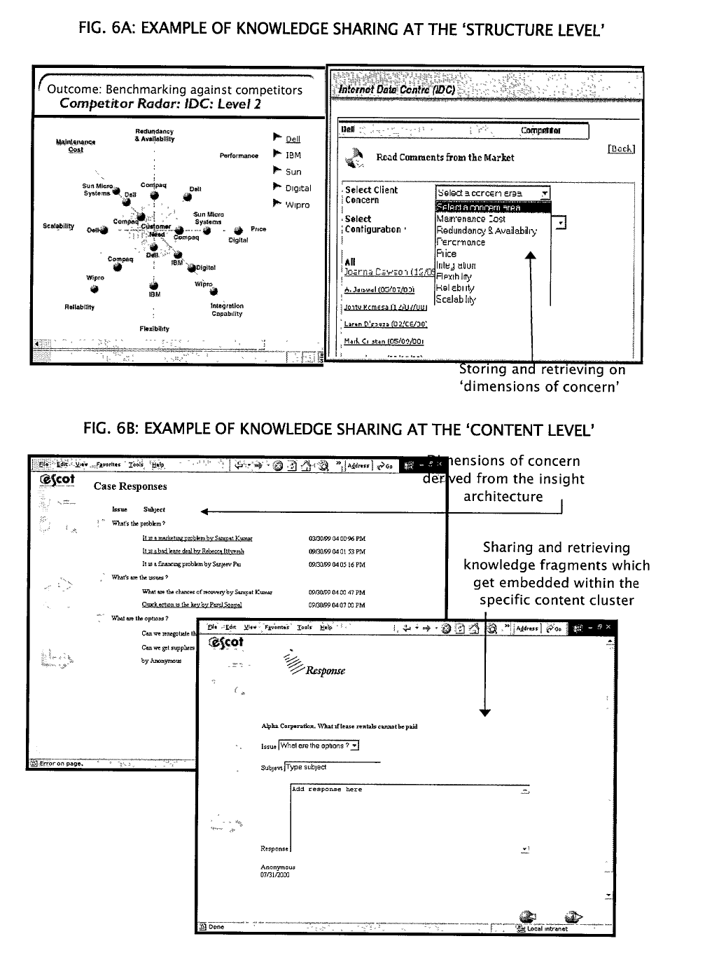

At the structural level, document sharing is dependent upon the specific context or role being enacted by the user. If the user is performing a task for the purpose of managing a process better, then the concerns are connected to meeting the process deliverables such as timeliness, quality etc. On the other hand, if the user is performing a task for the purpose of say selling, then the concerns are related to customer etc. In these two cases the community of sharing is also different. In the former the knowledge fragment needs to be shared among all the process owners, while in the latter, it may be shared among all those associated with selling. (See FIG. 6)

Even more important, since the same dimensions may be relevant to other groups of users, beyond those which can be clearly and immediately defined (such as customer issues related to product configuration which are useful not only to sales, but also to the product development team for that product), InDoCNet uses the mechanism of content hubs which store all the knowledge fragments created say around various dimensions of concern, and also go beyond by passing on these documents or information about them, to other content hubs which are organized around different processes or any other definition of role.

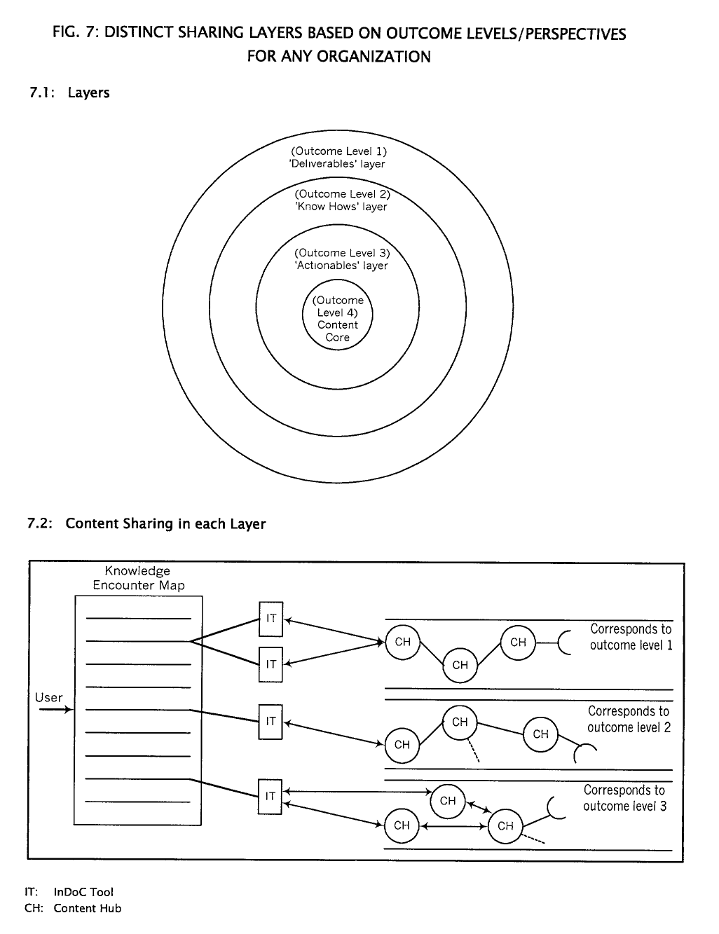

Thus, content hubs act as a knowledge router system similar to the structure of the Internet, in that the user may put in a knowledge fragment through an ESI, while executing a highly specific task in a large organization. The knowledge fragment so created, will be delivered into the relevant content hub to which the ESI is connected. Following this, the InDoC communication network takes over. The content hub passes on a copy of the knowledge fragment or information about it to all the content hubs to which it is connected. Each receiving content hub checks for appropriateness of role layer and the dimension of concern, and either stores the fragment and also passes it on to hubs connected to it, or simply passes on the information to the next hub. In this way a knowledge fragment travels across even an extremely large communication network and is captured and stored by all content hubs who find role and dimension of concern validity. (There may be other protocol elements added for the purpose of efficient transfer of fragments and optimal use of the network) (See FIG. 7)

Hence the content hubs enable the meaningful recontextualization of tacit knowledge fragments from one point of use to another.

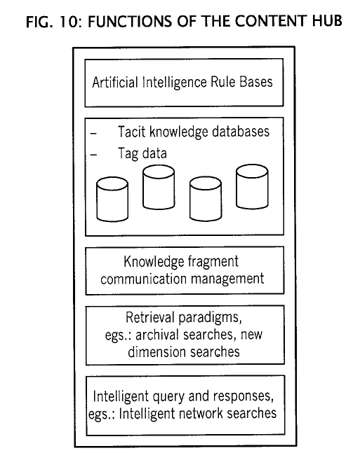

A Content Hub comprises of artificial intelligence rule bases and “knowledge architecture” structures, (such as those covered in the DISHA patent) along with delivery capabilities in terms of content reorganization and information object indexing. It also carries the knowledge fragment databases and tag data. It will also carry the knowledge fragment communication management protocols, retrieval paradigms such as archival searches and new dimension searches, intelligent query and response tools such as intelligent network searches, network groups etc. (See FIG. 10)

Procedure Defining The Knowledge Sharing Protocol in InDoCNet Architecture

The InDoCNet is a layered knowledge-sharing network. This is a framework for knowledge sharing across the organization, which maps onto the organizational architecture (described as a specific embodiment of DISHA covered in the patent application no. 117.008).

The knowledge sharing is carried out in the following manner, and is one of the bases for the protocol design:

a) A user enters a new tacit knowledge fragment, which is (auto or user) tagged on the relevant dimensions of concern.

b) This knowledge fragment along with the “tag” data gets stored on a content hub relevant to that role.

c) Based on the knowledge-sharing communication protocol, the content hub “talks” to linked content hubs and “relevantly passes” on the call-address of the knowledge fragment. These content hubs in turn “talk” to their linked content hubs and “relevantly pass” on the call-address of the knowledge fragment. In this way, the tacit knowledge fragments can be “relevantly passed” between content hubs based on the knowledge-sharing communication protocol, and the knowledge fragment can be retrieved from a different InDoC tool around a different outcome (within the same Outcome Level).

d) Hence the content hubs enable the meaningful recontextualization of tacit knowledge fragments from one point of use to another.

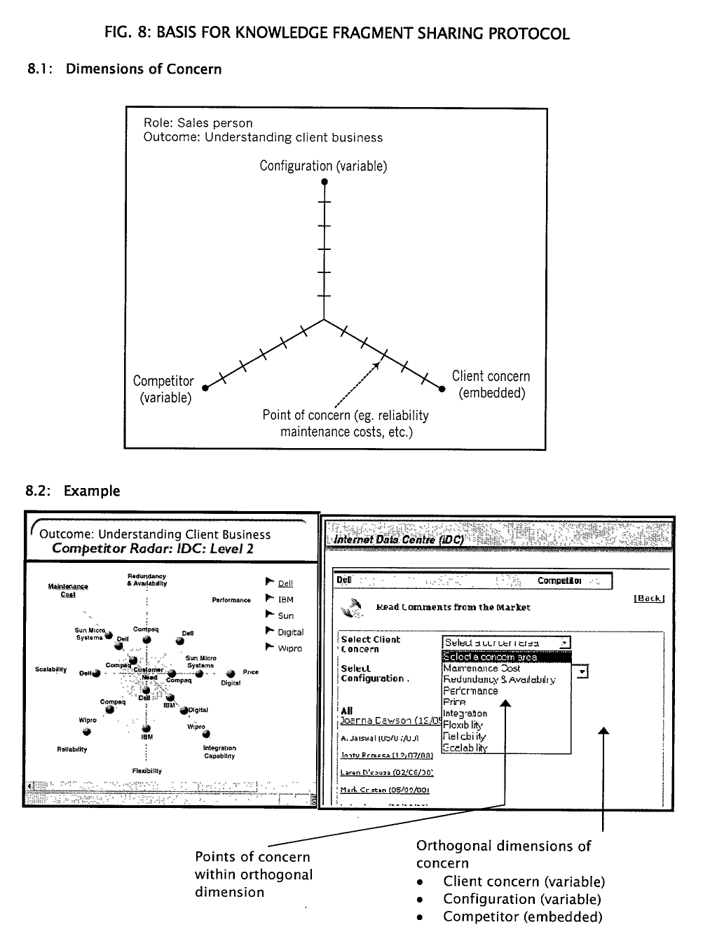

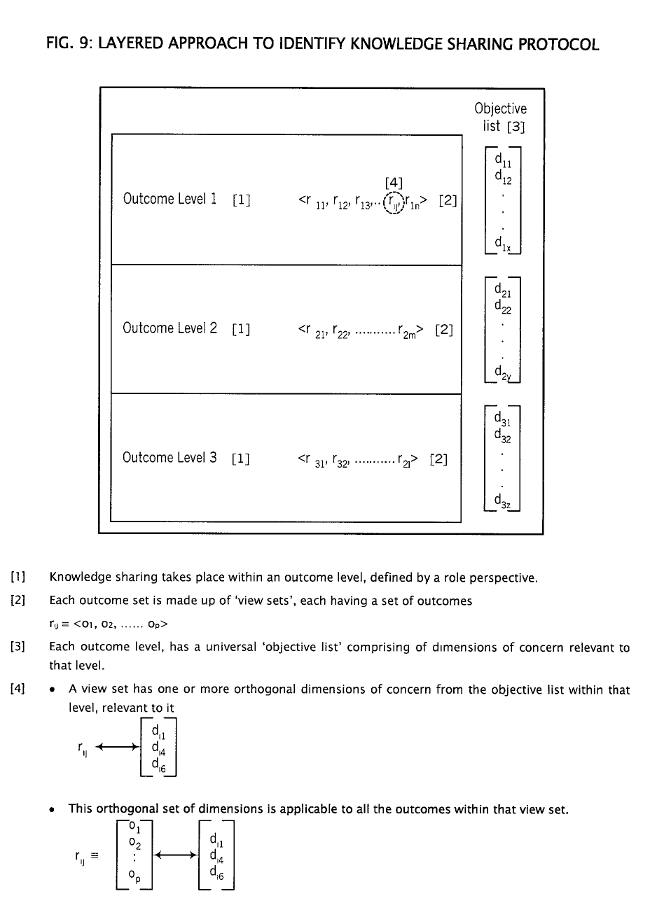

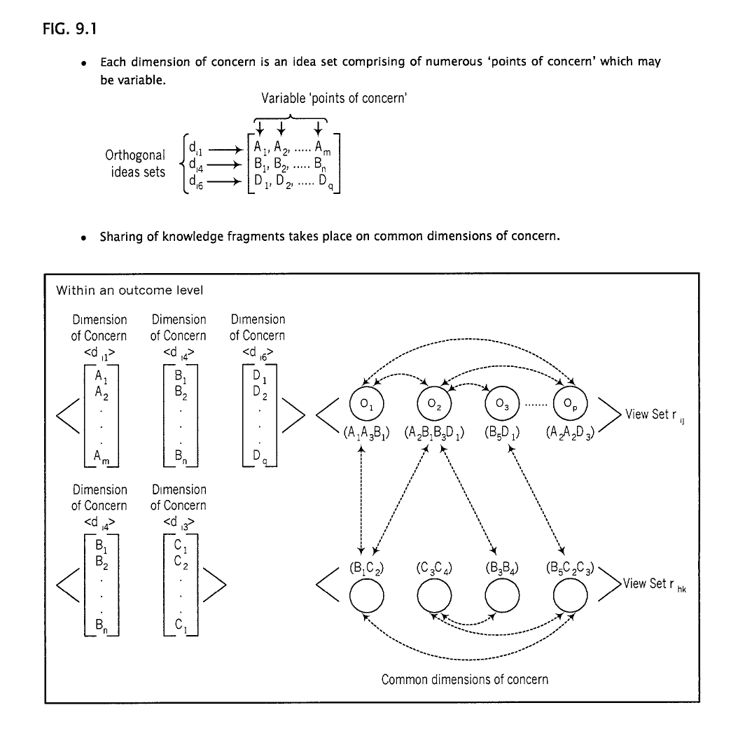

The “Dimensions of concern” form the basis of the knowledge-sharing communication protocol. The “Dimensions of concern” are derived from a role and are defined for an Outcome Level. These dimensions of concern, are organized into orthogonal “idea sets”. In this case, the orthogonal dimensions for the role “sales” are configuration, competitor and client concern. Each dimension forming an idea set comprising of variable “points of concern” example client concern may have reliability, maintenance costs etc. as points of concern. This is illustrated through an embodiment. (See FIG. 7 and 8)

FIGS. 7 and 8 represent the layered approach to identify the dimensions of concern, which form the basis of the knowledge-sharing communication protocol.

a) Outcome Levels are identified by a Role Perspective (covered in the DISHA patent). Knowledge sharing takes place only within an Outcome Level.

b) Each Outcome Level has a set of “View Sets”, each having a set of outcomes. Each level also has associated, a universal set or “objective list” comprising of all the orthogonal dimensions of concern relevant to that level.

c) Each View Set is associated with one or more orthogonal dimensions of concern relevant to it, from the universal “objective list”. These dimensions of concern are applicable to all the outcomes within that view set.

d) Each of these dimensions of concern is an idea set comprising of numerous “points of concern” which may be variable. Sharing of knowledge fragments takes place, based on the knowledge-sharing communication protocol, on common dimensions of concern.

The layered communication protocol would be built on the above principles, but is not limited to the above, the essential feature being the logical outcome driven layering and sharing on dimensions of concern using a hub and spoke transfer network.

### EXAMPLE 1

Sales InDoCNet—An Embodiment of the InDoCNet Technology Includes

A specific embodiment comprising of one of the most common sources of knowledge for a company is the numerous responses, ideas, suggestions and complaints given by customers in the course of business.

More specifically, a customer may have a number of opinions related to a product and the service associated with it. A discussion with a company representative centered around the attributes or features of the product may not result in the full extent of the customer's opinion being vocalized or articulated clearly. However, a discussion built around the theme of the customer's own problems could result in a much richer articulation of the ideas within the customer's head. This is a well-known phenomenon and market research questionnaires for example, incorporate this behavioral phenomenon into the very framing of questions.

The company's product design department on the other hand may be interested in the customers' responses not so much in terms of customer ‘feelings’ as much as in terms of specific suggestions or ideas to trigger off improvements in product design.

Yet in another department in the company, the customer service group may be interested in analyzing and extracting ideas from the customer data but from the perspective of improving customer service procedures or offerings.

The interactive document cluster meant to deal with the tacit knowledge generated and used in such a situation is built on the following framework (See FIGS. 5 and 8):

(a) the key axes of concern for the sales process are identified

(b) each axis of concern is further specified in terms of points of concern or specific issues of concern, for example if one of the axis of concern is customer needs, then each aspect of need which is relevant to that particular situation is identified within that axis

(c) using the axis of concern the method for tagging each document or fragment of tacit knowledge is established. The tag for a specific document will be built up as a combination of all the relevant issues from each of the ‘n’ number of concern paths. <issue choices from: concern path 1, concern path 2, . . . concern path n>

(d) a number of entry interfaces may be designed such that each entry interface will be presented to the user at the appropriate time when that person is discussing a specific concern path. At that stage the knowledge is captured and stored in that entry interface with the person who is capturing the knowledge is being the option of filling in any of the other dimension of concern on the basis of the content of the tacit knowledge being produced. Thus, the provocation for entry may come from a specific dimension, but the additional tagging of that fragment of knowledge is carried out on the basis of the content of the tacit knowledge.

(e) a number of knowledge display interfaces may be designed such that each seeker of knowledge may approach the body of knowledge from axis of concern or from a specific issue within that axis of concern. The user is now given the choice of retrieving all the tacit knowledge relevant to that concern.

(f) It is possible that knowledge derived from the sales process may be used in another organizational process, such as product design. It is also possible that the product design process may have its own axis of concern. However, it will be quite possible for seekers of knowledge within the product design process to retrieve knowledge captured in the selling process as long as there are one or more common dimensions of concern between the two different groups of seekers.

To achieve this, each role group within the organization connected with the selling process would be part of the customer knowledge sharing network through the mechanism of numerous role-specific content hubs; each content hub relating to a role, and carrying with it the dimensions of concern and role-based protocol for distributing and accepting new knowledge fragments.

Thus, developing individual concern architectures for different departments or user groups within the organization with common dimensions of concern tying them up in multiple ways can result in a organization-wide tacit knowledge storage and retrieval architecture (this will allow seamless use and flow of soft knowledge from different parts of the organization to those users within the same organizational system who require them).

The organization-wide protocol structure has been described in figure (See FIG. 7), it will be seen that the basic layers on which common sharing takes place are based on the core perspectives for the organization (defined in DISHA patent 117.008) as deliverables, know-how and actionables. Further, each content hub would be related to an element within the outcome set defined within the perspective level. For example, there would be a content hub relevant to a specific process which is one of the many processes within the know-how layer. The dimensions of concern would be established for the role: managing the specific process. The dimensions of concern so established may have commonalities and differences with other process managers, either on the basis of some meta-rules established for that purpose, or on and individualized basis. There will be multiple content hubs for different roles, such as managing different processes or contributing in different ways for execution of these processes, each with a different set of dimension of concern. Based on this, the content hub network will distribute the knowledge fragments across the system.

### EXAMPLE 2

Software Based Framework for Knowledge Extraction and Transfer of KnowHow in a Community of Practice (An Embodiment of InDoCNet)

One of the central issues facing most organizations and communities of practice, is the problem of effective capture of the tacit knowhow that resides with the older or more experienced members of that community. The formal capture of this knowhow, is necessary from multiple points of view (1) The community as a whole is interested in continuously advancing the state of the art, and can do it only by capturing and formalizing the experiences and insights of its members. (2) Older or more experienced members of the community are in a position to leverage their considerable knowledge if some reasonable means of capturing and commercially distributing that knowledge is available. (3) Younger and advancing members of the community gain by shortening considerably the gaps in knowledge caused by limited experience.

The present embodiment is both a framework for such extraction and distribution of tacit knowledge or knowhow (KnowHow Sharing Protocol), and also a toolkit for improving the effectiveness of any effort associated with building a knowhow reservoir (KnowHow Toolkit).

These are described below:

(A) The KnowHow Toolkit acts as the repository for the knowledge structures of the communities of practice. These structures may be embodied in the form of content development formats, content agents, concept organization algorithms, etc.

Key innovation is the development of a unique set of software based content extraction and presentation tools (based on Interactive Document Cluster), which organize information objects into meaningful patterns and equally important, enable “experts” with a fund of tacit knowledge to communicate or transfer their expertise or identify best practices easily through the same set of tools. The tools are described below:

1. Intelligent Content Agents, which perform the function of packaging information components into meaningful query and problem response structures for specific purpose. These agents are organized into multiple classes depending upon the (i) problem categories addressed, (ii) the heuristic frameworks used, and (iii) the information organizing principles.

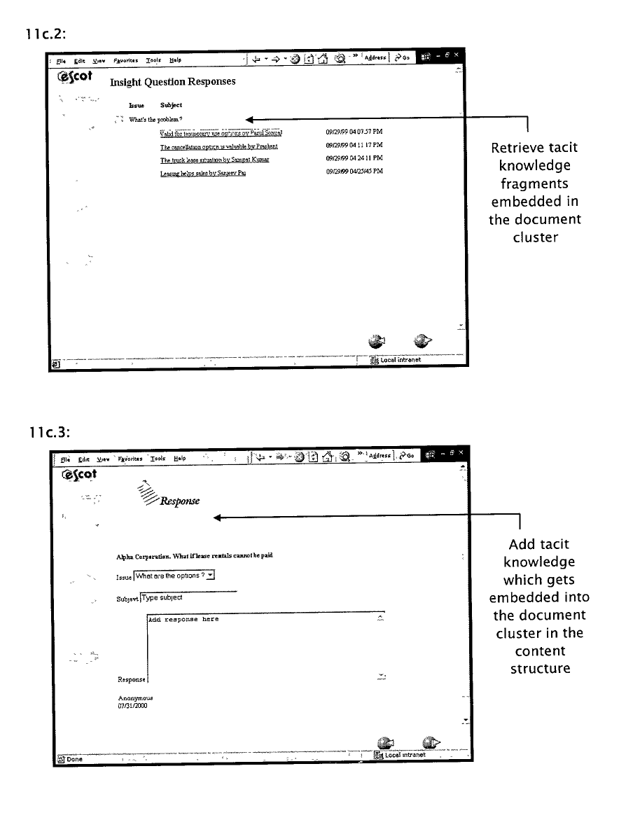

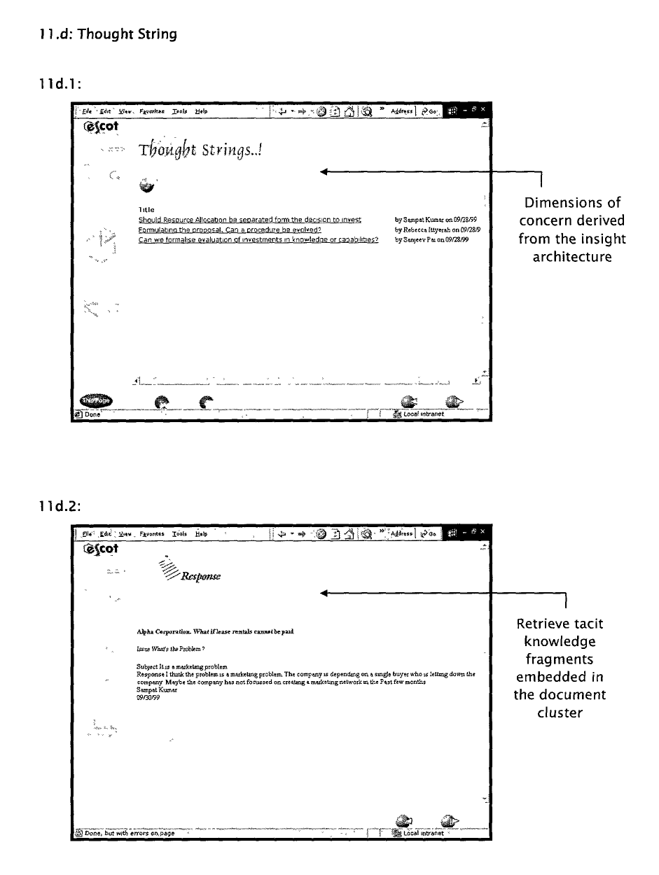

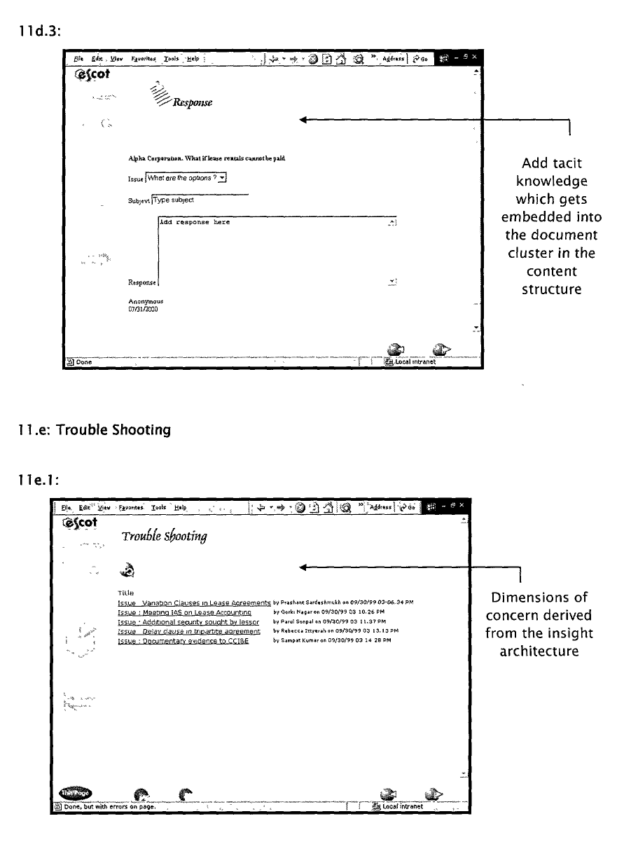

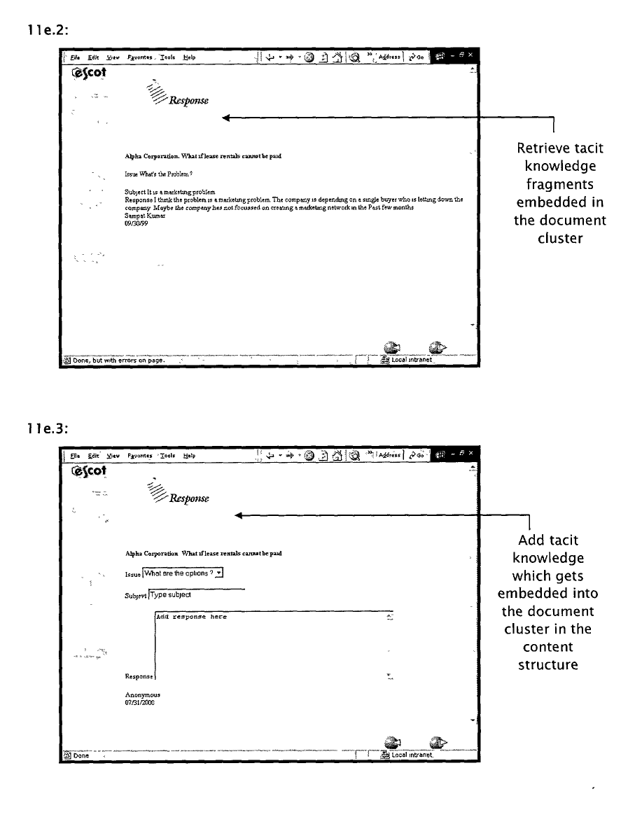

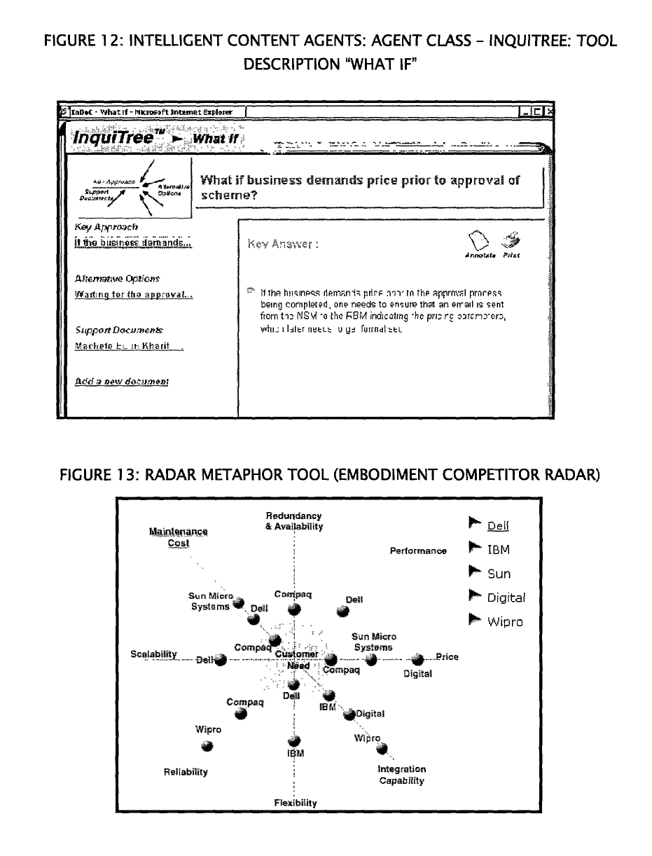

A simple Intelligent Content Agent is described below. This agent called ‘Inquitree what if’ is triggered by a specific “what if . . . ” Query and comprises of a solution framework art of an “appropriate content packs”. Agents carry with them development interfaces and tagging interfaces that allow them to be called in multiple applications and customized for specific purposes. A class of agent may result in hundreds of task-specific agents (See FIG. 12)

2. Intelligent Query Tools, which are formal software tools to aid in the knowledge extraction process by offering a sequence of queries to users on the basis of a prior reasoning architecture. Since the solution architecture for a class of problems is usually common (for example, developing a project plan), the Intelligent Query Tool is able to “anticipate” the issues likely to be faced in developing such a plan on the basis of past expert interactions with the same problem. This results in a query organization architecture that sequentially opens up questions on the basis of past choices and offers templates and content structures for storing the answers to the next question. This enables a high quality formal “think through process” of any common solution pathway and the capture of the unique or specific organizational practices in relation to the execution or response to that solution.

3. Map Metaphor Libraries, which provide ready-to-use frameworks to enable experts from a community of practice to articulate their knowledge meaningfully (for example, a competitor radar is derived from a radar metaphor tool, which provides the general framework that enables any expert to extract and store knowledge about a group of participants in terms of their relative performance on key identifiable dimensions.) Thus, a radar metaphor tool may be used not only to build competitor radar maps, but also benchmarking tools for any group of companies or divisions within companies for key set of parameters. Or in another set of variations, provides the basis for building a set of performance appraisal tools for a group of employees or groups of employees within a company on key operating dimensions.

As can be seen, a single Software Metaphor Tool enables the creation of numerous context specific maps, each of which can powerfully represent a set of tacit and explicit knowledge in a meaningful organization. These are called Software Metaphor Tools. (See FIG. 13)

Another embodiment of SMT's would include an Interaction Specification Metaphor Tool, which takes on specific map embodiments such as a task commitment map. The same tool would be used to build performance specification maps for say, a logistics transfer hub, like a warehouse.

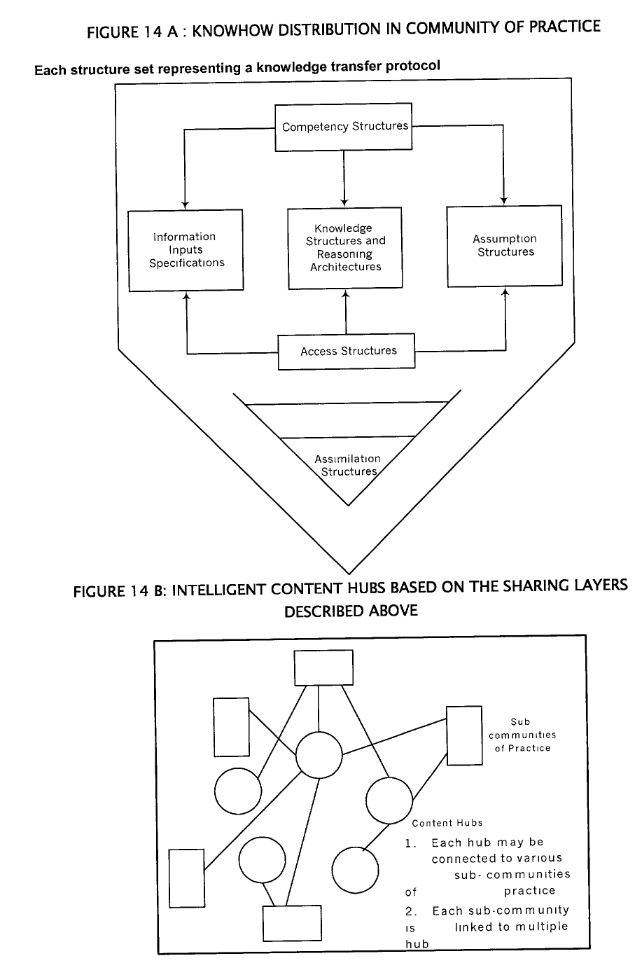

(B) The KnowHow Sharing Protocol for a community of practice is multilayered, with sharing mainly among and within a single layer. The protocol is built on three types of elements (a) the organization architecture (b) the knowledge use architecture, and (c) the information interaction framework. (See FIG. 14a) Each element described in the framework is a protocol layer defining knowledge communications and sharing rules.

Intelligent Content Hubs (See FIG. 14b) are organized in a unique manner in that they can act as a central group of hubs that provide support to multiple communities of practice or alternatively enable a single community of practice to quickly and effectively organize the content created by that community to be stored, classified, and tagged automatically for use across the organization. The additional key function of a Content Hub is to help find additional users for a piece of information created by one group of users across the organization.

The operation of the content hubs have been described earlier.

Each Content Hub comprises of artificial intelligence rule bases and “knowledge architecture” structures, (such as those covered in Disha and InDoC) along with delivery capabilities in terms of content reorganization and information object indexing.

These artificial intelligence rule bases, are organized around specific “dimensions of use” (such as processes, activities groups, etc.) or “dimensions of practice” (such as common tasks) and “dimensions of concern”. Content Hubs perform the specific function of allowing data fragments, information and content formats, and “intelligent content agents” to be built and shared across communities of practice and enable the meaningful recontextualisation of information from one group of users to another.

The knowledge transfer efforts may be aided by an object indexing rule-base, which sets up priorities and organizing rules for the co-classification of knowledge objects (i.e., if one object within a class is said to have an attribute, then all other information objects are also awarded the same attribute.) This object indexing rule-base may be in the form of a definitional component aiding the object addressing efforts, or may be in the form of additional, active content hubs, which collect, organize, and distribute content for a specific sub community of practice such as process team members in a large organization, on the basis of local protocols.

A preferred embodiment of a system in accordance with the present invention is preferably practiced in the context of a personal computer such as an IBM compatible personal computer, Apple Macintosh computer or UNIX based workstation. A representative hardware environment is one which includes a typical hardware configuration of a workstation in accordance with a preferred embodiment having a central processing unit, such as a microprocessor, and a number of other units interconnected via a system bus. The workstation includes a Random Access Memory (RAM), Read Only Memory (ROM), an I/O adapter for connecting peripheral devices such as disk storage units to the bus, a user interface adapter for connecting a keyboard, a mouse, a speaker, a microphone, and/or other user interface devices such as a touch screen (not shown) to the bus, communication adapter for connecting the workstation to a communication network (e.g., a data processing network) and a display adapter for connecting the bus to a display device. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

The present invention is not to be limited in scope by the embodiment disclosed in the example which is intended as an illustration of one aspect of the invention and any methods and devices which are functionally equivalent are within the scope of the invention. Indeed various modifications of the invention in addition to those shown and described herein will become apparent to those skilled in the art from the foregoing description.

Additional embodiments have been described in detail above wherein the figures have been described. (See FIGS. 11a to 11e).

What is claimed is:

1. A method of managing knowledge within an organization, said method comprising:
connecting a computer to a service provider;
running a browser on said computer;
receiving for core knowledge a request from a user;
prompting the user to respond to options and refine the knowledge request while storing the user's answers as knowledge fragments linked to the knowledge request; and while said browser is running and iteratively performing the following steps a-d:
a) assessing a knowledge base and retrieving the information control of said knowledge base in said computer;
b) identifying on said knowledge base one or more knowledge fragments linked to the core knowledge unit;
c) assessing said knowledge fragments and storing the information content of said different fragments in said computer; and
d) displaying said stored core knowledge and knowledge fragments on the computer.

2. The method of managing knowledge within an organization, including said service provider organizing and following competitors by using data storage unit.

3. The method according to claim 1 wherein the assessing and storing of information in step (c) is a continuous process, thereby resulting in a Learning History Cluster capturing the organization's experiences.

4. The method according to claim 3 including extracting tacit assumptions underlying work practices of individuals within the organization, and forming a cluster called Insight Cluster Networks for information about the organization.

5. The method according to claim 3, including recording knowledge fragments concerning data for day-to-day concern of the organization and forming an Activity Network Cluster.

6. A computer-implemented apparatus for classifying knowledge into an Interactive Document Cluster Network (InDocNet), said apparatus comprising:
a framework of a set of key axes of concern and points of concern;
said axis of concern providing links for tagging a document;
a set of entry interfaces;
a set of data storage units, and
a set of knowledge display interfaces.
